(19) United States
(12) Patent Application Publication
(10) Pub. No.: US 2025/0244265 A1
(43) Pub. Date: Jul. 31, 2025

(54) SYSTEMS AND METHODS FOR ADJUSTMENT OF XRF ANALYSIS STRATEGY

(71) Applicant: Thermo Scientific Portable Analytical Instruments, Tewksbury, MA (US)

(72) Inventor: Michael Dugas, Londonderry, NH (US)

(21) Appl. No.: 19/039,327

(22) Filed: Jan. 28, 2025

Related U.S. Application Data
(60) Provisional application No. 63/626,619, filed on Jan. 30, 2024.

(51) Int. Cl. G01N 23/223

(52) U.S. Cl. CPC G01N 23/223

(57) ABSTRACT

According to one aspect, a system for identifying an element is described that includes an X-ray source configured to direct x-ray energy to a sample; a detector configured to detect fluorescent emissions from the sample; and a processor configured to: produce an X-ray fluorescent spectrum from the detected fluorescent emissions, where the X-ray fluorescent spectrum is representative of an elemental composition of the sample; calculate a first concentration value for each element in the elemental composition using a first method; select an element from the elemental composition using the first concentration value; and recalculate the concentration value of the selected element using a second method.

### CROSS-REFERENCE TO RELATED APPLICATIONS

This application claims the benefit under 35 U.S.C. § 119(e) of U.S. Provisional Application No. 63/626,619 filed Jan. 30, 2024. The entire content of the aforementioned application is incorporated by reference herein.

### FIELD OF THE INVENTION

The present invention relates to devices and methods for identifying the concentration of elements within a sample using a portable device including an X-ray source, where concentration values for certain elements within a matrix are produced using a combination of methods.

### BACKGROUND OF THE INVENTION

X-ray fluorescence (XRF) instruments, such as field portable devices, are used by inspectors throughout the world to determine the elemental distributions in a wide variety of sample matrices that include soils, minerals, ceramics, metals, polymers, thin films, and paint on different substrates. The Thermo Scientific NITON XL5, for example, employs various algorithms to properly analyze the elemental composition in these different sample matrices. In general, a given instrument will be used in a specific instance for the analysis of a single class of samples, for example, sorting of alloys, or the analysis of soil samples, or analysis of the paint in houses. In such cases, the most effective use of the analyzer is to operate in a mode specifically developed to optimize performance for the sample class. The user selects from a menu on a touch screen or an associated computer, or the analyzer may perform automated routines to select the mode without user interventions. For example, the Thermo Scientific NITON XL5 can be used to analyze various elements in a sample matrix where the elements exhibit primary elemental spectral features using X-ray fluorescence. See for example U.S. Pat. No. 7,899,153 which is hereby incorporated by reference herein in its entirety for all purposes.

In typical applications, one or more algorithms are used to convert a detected XRF energy spectrum into analytical results that describe the elemental makeup of the sample being interrogated by the device. These algorithms derive a relationship between the spectral intensity of known elemental peaks and concentration of said element. Two of the most common techniques include Fundamental Parameters (FP) and empirical methodologies.

The FP method has the most dynamic range as it takes into account not only spectral intensity but also primary and secondary x-ray interaction of the elements in the sample. It is capable of quantification from 0-100% for a given element concentration. However, this broad dynamic range can often give up accuracy within smaller subsets of that range, say from 8.05-8.1%.

The empirical method has the least dynamic range however can yield the best accuracy within a smaller range. Typically, empirical methods draw a direct correlation between peak spectral intensity and concentration during the calibration process. Often a linear algebra equation is created, for example in the form of y=mX+b where y is the result and m is the count rate for said element, based on the correlation of spectral intensity, or count rate, and elemental concentration of known standards. When the user measures an unknown sample the count rate that corresponds to the element of interest is applied to the previously derived empirical equation to calculate the concentration of said element in the unknown sample. This technique can be very accurate within a relatively small range of concentration as the user can calibrate the device with multiple standards that are within said range. However, empirical calibration methods do not have the dynamic range that FP has (e.g. 0-100%) but are more commonly used across smaller ranges, such as for example +/−2% absolute. In addition, the empirical method often works best when the matrix is constant between the calibration samples and the unknown samples, FP however yields good results across many different matrices with reasonably good accuracy.

Typically, when a user utilizes an XRF analysis approach to determine the elemental makeup of a sample they select a mode, or method, of analysis such as: metals mode, soil mode, etc. These modes are pre-calibrated with a set of elements commonly found in that sample type. The calibration method used is often pre-determined, for example an element will either be calculated using FP or empirical methods. Within any given measurement, some elements may be calculated using FP while others, in the same reading, may be calculated using empirical. However, the method of analysis for each element is pre-determined before the measurement starts.

A need therefore exists for methods of using an XRF measurement device that maximizes dynamic range and accuracy of a measurement provided by both FP and empirical approaches.

### SUMMARY OF THE INVENTION

Systems, methods, and products to address these and other needs are described herein with respect to illustrative, non-limiting, implementations. Various alternatives, modifications and equivalents are possible.

According to one aspect, a system for identifying an element is described that includes an X-ray source configured to direct x-ray energy to a sample; a detector configured to detect fluorescent emissions from the sample; and a processor configured to: produce an X-ray fluorescent spectrum from the detected fluorescent emissions, where the X-ray fluorescent spectrum is representative of an elemental composition of the sample; calculate a first concentration value for each element in the elemental composition using a first method; select an element from the elemental composition using the first concentration value; and recalculate the concentration value of the selected element using a second method.

Also, a method of identifying an element is described that includes the steps of producing an X-ray fluorescent spectrum from the fluorescent emissions detected from a sample, where the X-ray fluorescent spectrum is representative of an elemental composition of the sample; calculating a first concentration value for each element in the elemental composition using a first method; selecting an element from the elemental composition using the first concentration value; and recalculating the concentration value of the selected element using a second method.

The above embodiments and implementations are not necessarily inclusive or exclusive of each other and may be combined in any manner that is non-conflicting and otherwise possible, whether they are presented in association with a same, or a different, embodiment or implementation. The description of one embodiment or implementation is not intended to be limiting with respect to other embodiments and/or implementations. Also, any one or more function, step, operation, or technique described elsewhere in this specification may, in alternative implementations, be combined with any one or more function, step, operation, or technique described in the summary. Thus, the above embodiment and implementations are illustrative rather than limiting.

### BRIEF DESCRIPTION OF THE DRAWINGS

The above and further features will be more clearly appreciated from the following detailed description when taken in conjunction with the accompanying drawings. In the drawings, like reference numerals indicate like structures, elements, or method steps and the leftmost digit of a reference numeral indicates the number of the figure in which the references element first appears (for example, element 110 appears first in FIG. 1). All of these conventions, however, are intended to be typical or illustrative, rather than limiting.

FIG. 1 is a functional block diagram of one embodiment of an XRF system in communication with a computer;

FIG. 2 is a simplified graphical example of one embodiment of the XRF system of FIG. 1 that includes a portable XRF system; and

FIG. 3 is a functional block diagram of one embodiment of a flowchart of methods described herein.

Like reference numerals refer to corresponding parts throughout the several views of the drawings.

### DETAILED DESCRIPTION

As will be described in greater detail below, aspects of the described invention include a system and method that utilizes a concentration value associated with an element produced using a first analysis strategy from an XRF spectrum of a sample material and recalculating the concentration value associated with the element using a second analysis strategy to produce a substantially improved result for the recalculated parameter.

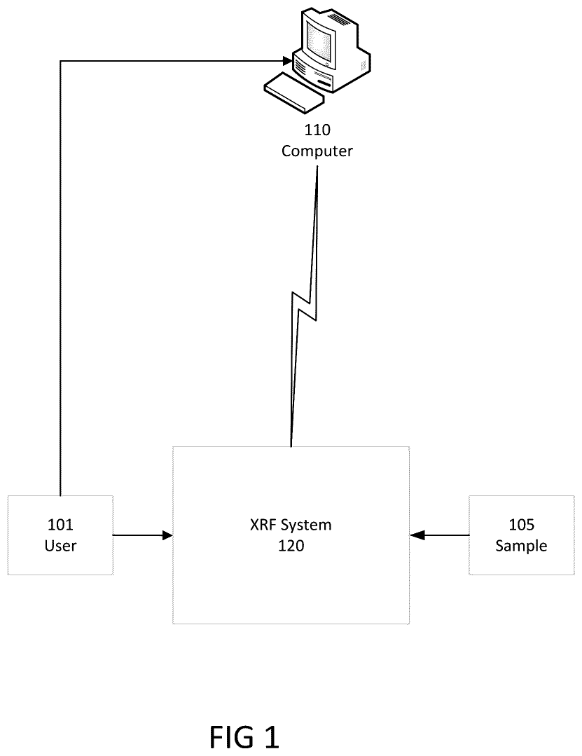

FIG. 1 provides a simplified illustrative example of user 101 capable of interacting with computer 110 and XRF system 120 as well as sample 105 which may include any type of sample typically analyzed by XRF technology. Embodiments of XRF system 120 may include a variety of commercially available XRF systems such as, for example, the NITON XL5 portable XRF device available from Thermo Fisher Scientific. FIG. 1 also illustrates a network connection between computer 110 and XRF system 120, however it will be appreciated that FIG. 1 is intended to be exemplary and additional or fewer network connections may be included. Further, the network connection between the elements may include “direct” wired or wireless data transmission (e.g. as represented by the lightning bolt) as well as “indirect” communication via other devices (e.g. switches, routers, controllers, computers, etc.) and therefore the example of FIG. 1 should not be considered as limiting.

Computer 110 may include any type of computing platform such as a workstation, a personal computer, a tablet, a “smart phone”, one or more servers, compute cluster (local or remote), or any other present or future computer or cluster of computers. Computers typically include known components such as one or more processors, an operating system, system memory, memory storage devices, input-output controllers, input-output devices, and display devices. It will also be appreciated that more than one implementation of computer 110 may be used to carry out various operations in different embodiments, and thus the representation of computer 110 in FIG. 1 should not be considered as limiting.

In some embodiments, computer 110 may employ a computer program product comprising a computer usable medium having control logic (e.g. computer software program, including program code) stored therein. The control logic, when executed by a processor, causes the processor to perform some or all of the functions described herein. In other embodiments, some functions are implemented primarily in hardware using, for example, a hardware state machine. Implementation of the hardware state machine so as to perform the functions described herein will be apparent to those skilled in the relevant arts. Also, in the same or other embodiments, computer 110 may employ an internet client that may include specialized software applications enabled to access remote information via a network. A network may include one or more of the many types of networks well known to those of ordinary skill in the art. For example, a network may include a local or wide area network that may employ what is commonly referred to as a TCP/IP protocol suite to communicate. A network may include a worldwide system of interconnected computer networks that is commonly referred to as the internet, or could also include various intranet architectures. Those of ordinary skill in the related art will also appreciate that some users in networked environments may prefer to employ what are generally referred to as “firewalls” (also sometimes referred to as Packet Filters, or Border Protection Devices) to control information traffic to and from hardware and/or software systems. For example, firewalls may comprise hardware or software elements or some combination thereof and are typically designed to enforce security policies put in place by users, such as for instance network administrators, etc.

According to one aspect, XRF system 120 may include a portable XRF device used to carry out the methods described herein. Suitable portable, field portable or handheld XRF devices known in the art may be modified by hardware or software to carry out the methods described herein. Such devices carry out nondestructive analysis of a sample compound or material. For example, XRF analyzers determine the chemistry of a sample by measuring the fluorescent (or secondary) X-ray emitted from a sample when it is excited by an X-ray source. Elements present in a sample produce a set of characteristic X-rays unique for that element.

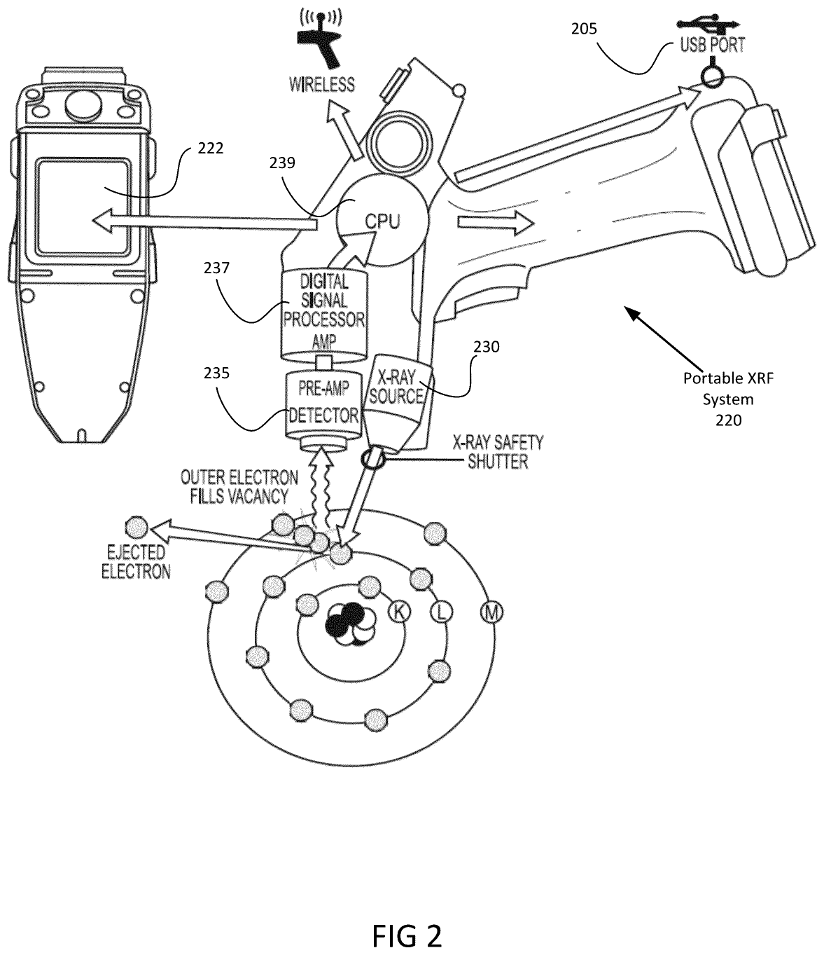

FIG. 2 provides a simplified illustrative example of one embodiment of XRF system 120 that includes a handheld device comprising X-ray source 230 and detector 235, illustrated as portable XRF system 220. Detector 235 is operatively connected to a digital signal processor 237 which is operatively connected to computer processing unit 239 adapted for use in portable, handheld, battery operated devices. According to one aspect, central processing unit 239 is capable of performing the necessary functions described herein to provide answers at the point of use while still remaining compatible with the requirements of portable devices. Portable XRF system 220 can optionally be connectedly wirelessly or by USB port 205 to computer 110 to provide additional capabilities including data transmission, instrument condition monitoring, device management, and additional computing resources for more advanced offline analysis. Portable XRF system 220 also includes a display 222 for displaying information or for inputting information or for selecting various analysis modes offered by the handheld device.

According to one aspect, portable XRF system 220 can operate (1) at a selected voltage of between 4 kV and 60 kV, (2) at a selected current of up to 1000 uA, (3) using a filter selected from among Al, Cu, Fe, Mo, or no filtration, including combinations thereof, and (4) for a selected period of time of between 3 and 300 seconds.

Atoms responsive to X-rays have several electron orbitals (K shell, L shell, M shell, for example). When X-ray energy causes electrons to transfer in and out of these shells, XRF peaks with varying intensities are created and will be present in the spectrum which is a graphical representation of X-ray peaks as a function of energy. The peak energy identifies the element, and the peak height/intensity is generally indicative of the concentration of the element in the sample. X-ray fluorescence methods are known to those of skill in the art and can be utilized in the present methods based on the present disclosure.

According to one aspect, a library of spectra of calibration samples is stored in portable XRF system 220. Such a library can be created using either fundamental parameters of empirical methods by scanning a calibration sample (1) at a selected voltage, (2) at a selected current, (3) using a selected filter, and (4) for a selected period of time. Portable XRF system 220 detects the fluorescent emissions from the calibration sample the stores the associated spectral information in the memory of the device. The process is generally repeated for each calibration sample of interest to create the library. Alternatively, a pre-created library can be uploaded into portable XRF system 220 via the wireless or USB connection.

According to one aspect, user 101 may perform a scan of sample 105 using a preconfigured set of parameters. Sample 105, which may be known or unknown, is irradiated with X-ray energy emanating from x-ray source 230 of portable XRF system 220. According to one aspect, the endpoint energy of an X-ray tube of x-ray source 230 can be from 4 kV to 10 kV. The X-ray energy emitted by x-ray source 230 is normally not filtered in low energy measurements that are desirable for detection of light elements, but can be filtered to optimize the excitation spectrum as has been demonstrated in the art. The use of an X-ray source, such as an X-ray tube, and the use of a window and/or elemental filter, such as a Cu filter or otherwise, are standard XRF techniques, described, for example, in U.S. Pat. No. 6,765,986, to Grodzins et al., which is incorporated herein by reference.

In the scan, radiation scattered by, and/or resonantly emitted (fluoresced) by sample 105 is detected and sorted by the signal processor in terms of energy within portable XRF system 220. The signal processor then analyzes the detected fluorescence to identify one or more elements or atoms. For example, signal processor 237 and/or CPU 239 may perform analysis using the library to identify characteristic peaks in the detected spectrum from sample 105 indicative of one or more elements and/or matrix material that encase the elements (e.g. using fundamental parameters). Those of ordinary skill appreciate that matrix material may include any material that encases various types of elements.

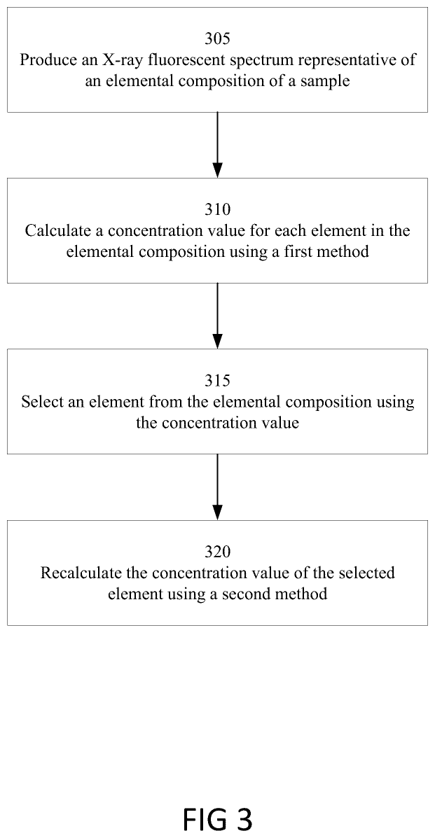

FIG. 3 provides an illustrative example of a method of analysis for a given element that is dynamically changed during the analysis to yield the most accurate results. In step 305, a processor (e.g. signal processor 237 and/or CPU 239) produces an XRF spectrum from sample 105. The XRF spectrum is representative of an elemental composition of sample 105 and includes one or more peaks associated with individual elements encased in a matrix as well as the matrix material itself.

In step 310, the processor calculates a concentration value for each of the elements in the XRF spectrum using a first analysis method that typically includes a fundamental parameters method. Then, in step 315, the processor selects an element that has a concentration value within a specified range of values. According to one aspect, the specified range of values indicate a range of concentration for the specific element where a second analysis method (e.g. an empirical method) typically provides a more accurate result than the first analysis method. Further, each element typically has a range of concentration values specific to that element.

In step 320 the processor recalculates the concentration value of the selected element using the second method, such as an empirical method. According to one aspect, the processor displays the element identifier and recalculated concentration value to user 101.

### Example I

In the described example, a strategy of measurement starts by utilizing a Fundamental Parameters method to identify the matrix and other elements within the matrix. Then, for some elements, the analysis method switches from the Fundamental Parameters method to a pre-derived empirical equation based on the matrix and the calculated results from the Fundamental Parameters method. In the described example, if a copper element is calculated by Fundamental Parameters method to be 8.0% in a sample with an iron matrix, the system may be pre-loaded with an empirical equation that is used with copper elements when the calculated concentration is in a range between 7.8 and 8.2%. In this case, the Fundamental Parameters method result of 8.0% would be recalculated using the empirical method which would yield a slightly different, often more accurate, result for the copper element (e.g. 8.032%). However, if the Fundamental Parameters method initially calculated the copper element result as 5% then, based on the settings, the Fundamental Parameters method results would not be overwritten by an empirical equation.

### Example II

Low alloy steels (LAS) typically contain >95% iron and low levels of other elements. Nickel (Ni) is typically 0.02 to 0.2% and the Fundamental Parameters method is not accurate for Ni in Iron (Fe) at those levels. An empirical equation that is used for Ni from 0.0-0.3% has shown improved accuracy and detection limits whereby the Fundamental Parameters method could not detect 0.04% Ni in LAS however an empirical equation can easily detect and accurately quantify +/−0.005% or better.

What is claimed is:

1. A system for identifying an element comprising:
an X-ray source configured to direct x-ray energy to a sample;
a detector configured to detect fluorescent emissions from the sample; and
a processor configured to:
produce an X-ray fluorescent spectrum from the detected fluorescent emissions, wherein the X-ray fluorescent spectrum is representative of an elemental composition of the sample;
calculate a first concentration value for each element in the elemental composition using a first method;
select an element from the elemental composition using the first concentration value; and
recalculate the concentration value of the selected element using a second method.

2. The system of claim 1, further comprising:
a display configured to provide a representation of the recalculated concentration value of the selected element to a user.

3. The system of claim 1, wherein:
The first method comprises a fundamental parameters method and the second method comprises an empirical method.

4. The system of claim 1, wherein:
the processor identifies a matrix composition from the X-ray fluorescence spectrum using the first method.

5. The system of claim 1, wherein:
the processor selects the element if the first concentration value is within a range of concentration values.

6. The system of claim 5, wherein:
the range of the concentration values is specific to the element.

7. The system of claim 6, wherein:
the element comprises copper, wherein the range of the concentration values for copper is between 7.8% and 8.2%.

8. The system of claim 6, wherein:
the element comprises nickel, wherein the range of the concentration values for nickel is between 0.02% and 0.2%.

9. The system of claim 1, wherein:
the processor selects a plurality of the elements.

10. The system of claim 1, wherein:
the recalculated concentration value is more accurate than the first concentration value for the selected element.

11. A method of identifying an element comprising:
producing an X-ray fluorescent spectrum from the fluorescent emissions detected from a sample, wherein the X-ray fluorescent spectrum is representative of an elemental composition of the sample;
calculating a first concentration value for each element in the elemental composition using a first method;
selecting an element from the elemental composition using the first concentration value; and
recalculating the concentration value of the selected element using a second method.

12. The method of claim 11, further comprising:
providing a representation of the recalculated concentration value of the selected element to a user.

13. The method of claim 11, wherein:
the first method comprises a fundamental parameters method and the second method comprises an empirical method.

14. The method of claim 11, further comprising:
identifying a matrix composition from the X-ray fluorescence spectrum using the first method.

15. The method of claim 11, wherein:
the element is selected if the first concentration value is within a range of concentration values.

16. The method of claim 15, wherein:
the range of the concentration values is specific to the element.

17. The method of claim 16, wherein:
the element comprises copper, wherein the range of the concentration values for copper is between 7.8% and 8.2%.

18. The method of claim 16, wherein:
the element comprises nickel, wherein the range of the concentration values for nickel is between 0.02% and 0.2%.

19. The method of claim 11, wherein:
selecting a plurality of the elements from the elemental composition using the concentration values for each element.

20. The method of claim 11, wherein:
the recalculated concentration value is more accurate than the first concentration value for the selected element.
